(19) United States
(12) Patent Application Publication
(10) Pub. No.: US 2018/0359284 A1
(43) Pub. Date: Dec. 13, 2018

(54) SYSTEM AND METHOD FOR SIGNALING BY A DUAL-SIM DUAL-STANDBY DEVICE

(71) Applicant: QUALCOMM Incorporated, San Diego, CA (US)

(72) Inventors: Ravi Kanth KOTREKA, Hyderabad (IN); Harinath Reddy PATEL, Mahabubnagar (IN); Ashutosh GUPTA, Hyderabad (IN)

(21) Appl. No.: 15/619,373

(22) Filed: Jun. 9, 2017

(51) Int. Cl. H04L 29/06; H04B 1/3816; H04L 5/00

(52) U.S. Cl. CPC H04L 65/1006; H04B 1/3816; H04W 88/06; H04L 5/0055; H04L 65/1066

(57) ABSTRACT

A dual subscriber identity module (SIM) dual standby (DSDS) device may determine that the DSDS device is to communicate in a first communication session of the DSDS device instead of a second communication session of the DSDS device when the first communication session of the DSDS device and the second communication session of the DSDS device are contemporaneously active. The DSDS device may generate a session initiation protocol (SIP) message to pause the second communication session with another device based on the determination that the DSDS device is to communicate in the first communication session instead of the second communication session associated with the DSDS device. The DSDS device may transmit the generated SIP message to the other device associated with second communication session to pause the second communication session associated with the other device.

### BACKGROUND

### Field

The present disclosure relates generally to communication systems, and more particularly, to session initiation protocol signaling by a dual-subscriber identity module, dual-standby device.

### Background

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be or may be included in a dual subscriber identity module (SIM) dual standby (DSDS) device. The apparatus may determine that the DSDS device is to communicate in a first communication session of the DSDS device instead of a second communication session of the DSDS device when the first communication session of the DSDS device and the second communication session of the DSDS device are contemporaneously active. The apparatus may generate a session initiation protocol (SIP) message to pause the second communication session with another device based on the determination that the DSDS device is to communicate in the first communication session instead of the second communication session associated with the DSDS device. The apparatus may transmit the generated SIP message to the other device associated with second communication session to pause the second communication session associated with the other device. In an aspect, the generated SIP message includes a session description protocol (SDP) parameter that requests the other device to stop transmitting data to the DSDS device. In an aspect, the SDP parameter indicates that the DSDS device is to be in an inactive state or a send only state. In an aspect, the generated SIP message further comprises one or more additional SDP parameters indicating a time duration for which to pause the second communication session. In an aspect, the one or more additional SDP parameters include a first start time parameter that indicates a start time of the second communication session, a first stop time parameter that indicates a time at which the second communication session will be paused, a second start time parameter that indicates a time corresponding to an end of the time duration for which to pause the second communication session, and a second stop time that indicates whether a subsequent stop time is associated with the second communication session. In an aspect, the apparatus may further transmit a second SIP message to resume the second communication session with the other device, and the second SIP message may include an SDP parameter indicating that the DSDS device is to be in a send and receive state. In an aspect, the apparatus may further receive an acknowledgment from the other device indicating resumption of the second communication session.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a wireless communications system and an access network.

FIGS. 2A, 2B, 2C, and 2D are diagrams illustrating examples of a DL frame structure, DL channels within the DL frame structure, an UL frame structure, and UL channels within the UL frame structure, respectively.

FIG. 3 is a diagram illustrating an example of a base station and user equipment (UE) in an access network.

FIG. 4 is a diagram of a wireless communications system.

FIG. 5 is a call flow diagram of a wireless communications system.

FIG. 6 is a flowchart of a method of wireless communication.

FIG. 7 is a conceptual data flow diagram illustrating the data flow between different means/components in an exemplary apparatus.

FIG. 8 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

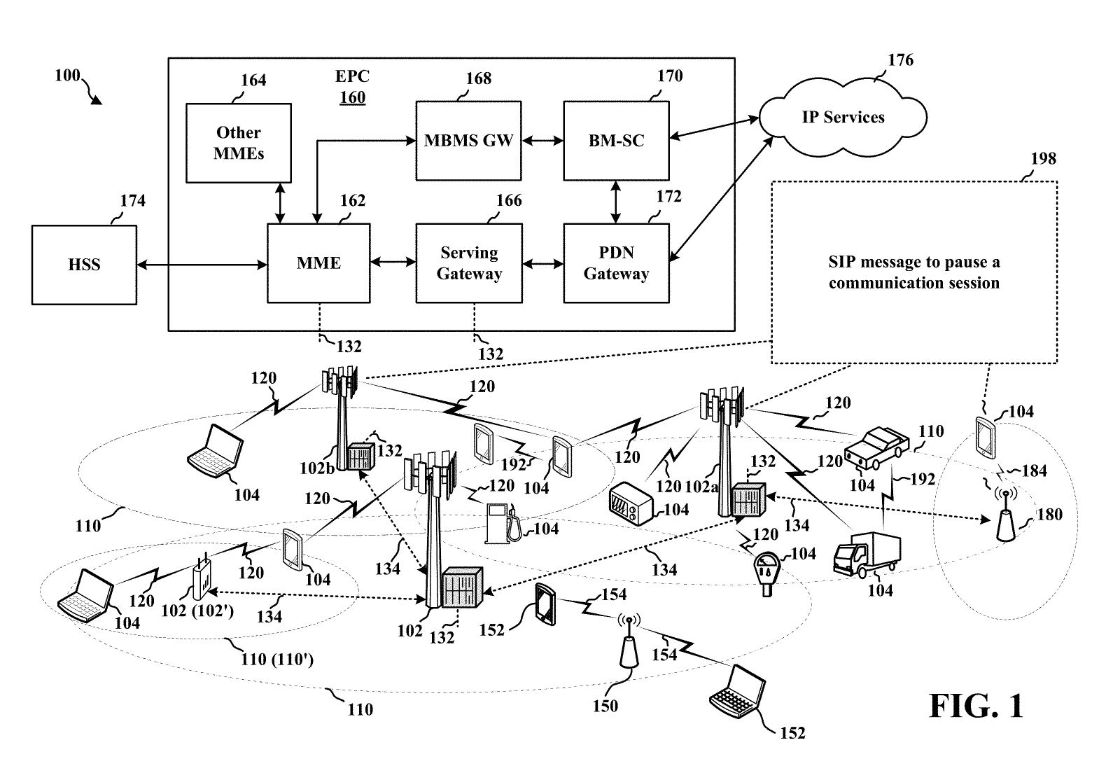

FIG. 1 is a diagram illustrating an example of a wireless communications system and an access network 100. The wireless communications system (also referred to as a wireless wide area network (WWAN)) includes base stations 102, UEs 104, and an Evolved Packet Core (EPC) 160. The base stations 102 may include macro cells (high power cellular base station) and/or small cells (low power cellular base station). The macro cells include base stations. The small cells include femtocells, picocells, and microcells.

The base stations 102 (collectively referred to as Evolved Universal Mobile Telecommunications System (UMTS) Terrestrial Radio Access Network (E-UTRAN)) interface with the EPC 160 through backhaul links 132 (e.g., S1 interface). In addition to other functions, the base stations 102 may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, and delivery of warning messages. The base stations 102 may communicate directly or indirectly (e.g., through the EPC 160) with each other over backhaul links 134 (e.g., X2 interface). The backhaul links 134 may be wired or wireless.

The base stations 102 may wirelessly communicate with the UEs 104. Each of the base stations 102 may provide communication coverage for a respective geographic coverage area 110. There may be overlapping geographic coverage areas 110. For example, the small cell 102′ may have a coverage area 110′ that overlaps the coverage area 110 of one or more macro base stations 102. A network that includes both small cell and macro cells may be known as a heterogeneous network. A heterogeneous network may also include Home Evolved Node Bs (eNBs) (HeNBs), which may provide service to a restricted group known as a closed subscriber group (CSG). The communication links 120 between the base stations 102 and the UEs 104 may include uplink (UL) (also referred to as reverse link) transmissions from a UE 104 to a base station 102 and/or downlink (DL) (also referred to as forward link) transmissions from a base station 102 to a UE 104. The communication links 120 may use multiple-input and multiple-output (MIMO) antenna technology, including spatial multiplexing, beamforming, and/or transmit diversity. The communication links may be through one or more carriers. The base stations 102/UEs 104 may use spectrum up to Y MHz (e.g., 5, 10, 15, 20, 100 MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or less carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 192. The D2D communication link 192 may use the DL/UL WWAN spectrum. The D2D communication link 192 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, LTE, or NR.

The wireless communications system may further include a Wi-Fi access point (AP) 150 in communication with Wi-Fi stations (STAs) 152 via communication links 154 in a 5 GHz unlicensed frequency spectrum. When communicating in an unlicensed frequency spectrum, the STAs 152/AP 150 may perform a clear channel assessment (CCA) prior to communicating in order to determine whether the channel is available.

The small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. The small cell 102′, employing NR in an unlicensed frequency spectrum, may boost coverage to and/or increase capacity of the access network.

The gNodeB (gNB) 180 may operate in millimeter wave (mmW) frequencies and/or near mmW frequencies in communication with the UE 104. When the gNB 180 operates in mmW or near mmW frequencies, the gNB 180 may be referred to as an mmW base station. Extremely high frequency (EHF) is part of the radio frequency (RF) in the electromagnetic spectrum. EHF has a range of 30 GHz to 300 GHz and a wavelength between 1 millimeter and 10 millimeters. Radio waves in the band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band has extremely high path loss and a short range. The mmW base station 180 may utilize beamforming 184 with the UE 104 to compensate for the extremely high path loss and short range.

The EPC 160 may include a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and a Packet Data Network (PDN) Gateway 172. The MME 162 may be in communication with a Home Subscriber Server (HSS) 174. The MME 162 is the control node that processes the signaling between the UEs 104 and the EPC 160. Generally, the MME 162 provides bearer and connection management. All user Internet protocol (IP) packets are transferred through the Serving Gateway 166, which itself is connected to the PDN Gateway 172. The PDN Gateway 172 provides UE IP address allocation as well as other functions. The PDN Gateway 172 and the BM-SC 170 are connected to the IP Services 176. The IP Services 176 may include the Internet, an intranet, an IP Multimedia System (IMS), a PS Streaming Service, and/or other IP services. The BM-SC 170 may provide functions for MBMS user service provisioning and delivery. The BM-SC 170 may serve as an entry point for content provider MBMS transmission, may be used to authorize and initiate MBMS Bearer Services within a public land mobile network (PLMN), and may be used to schedule MBMS transmissions. The MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

The base station may also be referred to as a gNB, Node B, evolved Node B (eNB), an access point, a base transceiver station, a radio base station, a radio transceiver, a transceiver function, a basic service set (BSS), an extended service set (ESS), or some other suitable terminology. The base station 102 provides an access point to the EPC 160 for a UE 104. Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a toaster, or any other similar functioning device. Some of the UEs 104 may be referred to as IoT devices (e.g., parking meter, gas pump, toaster, vehicles, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

Referring again to FIG. 1, in certain aspects, the UE 104 may be a dual-subscriber identity module (SIM), dual-standby (DSDS) device. The UE 104 may determine that the UE 104 is to communicate in a first communication session of the UE 104 instead of a second communication session of the UE 104 when the first communication session of the UE 104 and the second communication session of the UE 104 are contemporaneously active. For example, the UE 104 may determine that the UE 104 is contemporaneously maintaining active communication sessions with a first base station 102a and a second base station 102b. The UE 104 may generate a session initiation protocol (SIP) message 198 to pause the second communication session with another device based on the determination that UE 104 is to communicate in the first communication session instead of the second communication session associated with the UE 104. For example, the UE 104 may generate a SIP message 198 to pause the second communication session with the second base station 102b. The UE 104 may transmit the generated SIP message 198 to the other device associated with second communication session (e.g., the second base station 102b) to pause the second communication session. In an aspect, the generated SIP message 198 includes a session description protocol (SDP) parameter that requests the other device (e.g., the second base station 102b) to stop transmitting data to the UE 104. In an aspect, the SDP parameter indicates that the UE 104 is to be in an inactive state or a send only state. In an aspect, the generated SIP message 198 further includes one or more additional SDP parameters indicating a time duration for which to pause the second communication session. In an aspect, the one or more additional SDP parameters include a first start time parameter that indicates a start time of the second communication session, a first stop time parameter that indicates a time at which the second communication session will be paused, a second start time parameter that indicates a time corresponding to an end of the time duration for which to pause the second communication session, and a second stop time that indicates whether a subsequent stop time is associated with the second communication session. In an aspect, the UE 104 may further transmit a second SIP message to resume the second communication session with the other device (e.g., the second base station 102b), and the second SIP message may include an SDP parameter indicating that the UE 104 is to be in a send and receive state. In an aspect, the UE 104 may further receive an acknowledgment from the other device (e.g., the second base station 102b) indicating resumption of the second communication session.

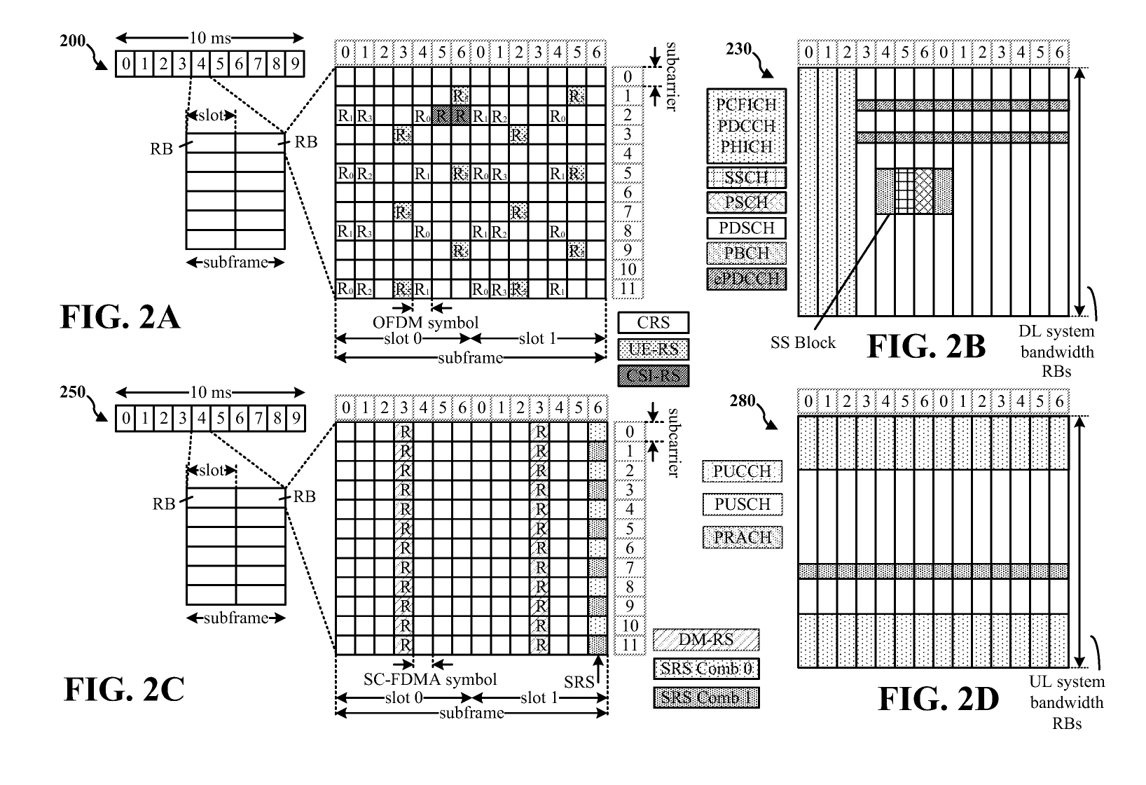

FIG. 2A is a diagram 200 illustrating an example of a DL frame structure. FIG. 2B is a diagram 230 illustrating an example of channels within the DL frame structure. FIG. 2C is a diagram 250 illustrating an example of an UL frame structure. FIG. 2D is a diagram 280 illustrating an example of channels within the UL frame structure. Other wireless communication technologies may have a different frame structure and/or different channels. A frame (10 ms) may be divided into 10 equally sized subframes. Each subframe may include two consecutive time slots. A resource grid may be used to represent the two time slots, each time slot including one or more time concurrent resource blocks (RBs) (also referred to as physical RBs (PRBs)). The resource grid is divided into multiple resource elements (REs). For a normal cyclic prefix, an RB may contain 12 consecutive subcarriers in the frequency domain and 7 consecutive symbols (for DL, OFDM symbols; for UL, SC-FDMA symbols) in the time domain, for a total of 84 REs. For an extended cyclic prefix, an RB may contain 12 consecutive subcarriers in the frequency domain and 6 consecutive symbols in the time domain, for a total of 72 REs. The number of bits carried by each RE depends on the modulation scheme.

As illustrated in FIG. 2A, some of the REs carry DL reference (pilot) signals (DL-RS) for channel estimation at the UE. The DL-RS may include cell-specific reference signals (CRS) (also sometimes called common RS), UE-specific reference signals (UE-RS), and channel state information reference signals (CSI-RS). FIG. 2A illustrates CRS for antenna ports 0, 1, 2, and 3 (indicated as R₀, R₁, R₂, and R₃, respectively), UE-RS for antenna port 5 (indicated as R₅), and CSI-RS for antenna port 15 (indicated as R).

FIG. 2B illustrates an example of various channels within a DL subframe of a frame. The physical control format indicator channel (PCFICH) is within symbol 0 of slot 0, and carries a control format indicator (CFI) that indicates whether the physical downlink control channel (PDCCH) occupies 1, 2, or 3 symbols (FIG. 2B illustrates a PDCCH that occupies 3 symbols). The PDCCH carries downlink control information (DCI) within one or more control channel elements (CCEs), each CCE including nine RE groups (REGs), each REG including four consecutive REs in an OFDM symbol. A UE may be configured with a UE-specific enhanced PDCCH (ePDCCH) that also carries DCI. The ePDCCH may have 2, 4, or 8 RB pairs (FIG. 2B shows two RB pairs, each subset including one RB pair). The physical hybrid automatic repeat request (ARQ) (HARQ) indicator channel (PHICH) is also within symbol 0 of slot 0 and carries the HARQ indicator (HI) that indicates HARQ acknowledgement (ACK)/negative ACK (NACK) feedback based on the physical uplink shared channel (PUSCH). The primary synchronization channel (PSCH) may be within symbol 6 of slot 0 within subframes 0 and 5 of a frame. The PSCH carries a primary synchronization signal (PSS) that is used by a UE 104 to determine subframe/symbol timing and a physical layer identity. The secondary synchronization channel (SSCH) may be within symbol 5 of slot 0 within subframes 0 and 5 of a frame. The SSCH carries a secondary synchronization signal (SSS) that is used by a UE to determine a physical layer cell identity group number and radio frame timing. Based on the physical layer identity and the physical layer cell identity group number, the UE can determine a physical cell identifier (PCI). Based on the PCI, the UE can determine the locations of the aforementioned DL-RS. The physical broadcast channel (PBCH), which carries a master information block (MIB), may be logically grouped with the PSCH and SSCH to form a synchronization signal (SS) block. The MIB provides a number of RBs in the DL system bandwidth, a PHICH configuration, and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry demodulation reference signals (DM-RS) for channel estimation at the base station. The UE may additionally transmit sounding reference signals (SRS) in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various channels within an UL subframe of a frame. A physical random access channel (PRACH) may be within one or more subframes within a frame based on the PRACH configuration. The PRACH may include six consecutive RB pairs within a subframe. The PRACH allows the UE to perform initial system access and achieve UL synchronization. A physical uplink control channel (PUCCH) may be located on edges of the UL system bandwidth. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

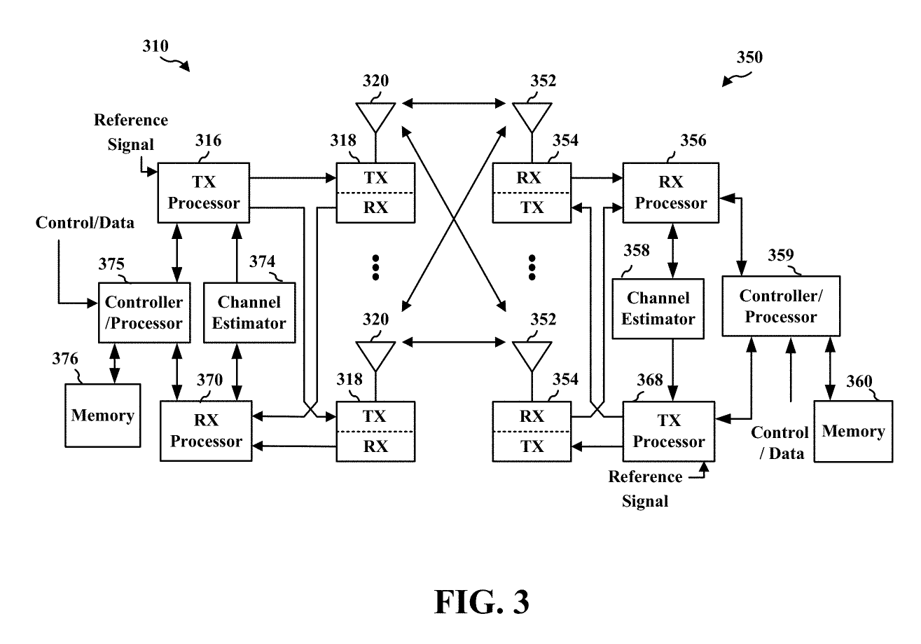

FIG. 3 is a block diagram of a base station 310 in communication with a UE 350 in an access network. In the DL, IP packets from the EPC 160 may be provided to a controller/processor 375. The controller/processor 375 implements layer 3 and layer 2 functionality. Layer 3 includes a radio resource control (RRC) layer, and layer 2 includes a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318TX. Each transmitter 318TX may modulate an RF carrier with a respective spatial stream for transmission.

At the UE 350, each receiver 354RX receives a signal through its respective antenna 352. Each receiver 354RX recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with a memory 360 that stores program codes and data. The memory 360 may be referred to as a computer-readable medium. In the UL, the controller/processor 359 provides demultiplexing between transport and logical channels, packet reassembly, deciphering, header decompression, and control signal processing to recover IP packets from the EPC 160. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIB s) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354TX. Each transmitter 354TX may modulate an RF carrier with a respective spatial stream for transmission.

The UL transmission is processed at the base station 310 in a manner similar to that described in connection with the receiver function at the UE 350. Each receiver 318RX receives a signal through its respective antenna 320. Each receiver 318RX recovers information modulated onto an RF carrier and provides the information to a RX processor 370.

The controller/processor 375 can be associated with a memory 376 that stores program codes and data. The memory 376 may be referred to as a computer-readable medium. In the UL, the controller/processor 375 provides demultiplexing between transport and logical channels, packet reassembly, deciphering, header decompression, control signal processing to recover IP packets from the UE 350. IP packets from the controller/processor 375 may be provided to the EPC 160. The controller/processor 375 is also responsible for error detection using an ACK and/or NACK protocol to support HARQ operations.

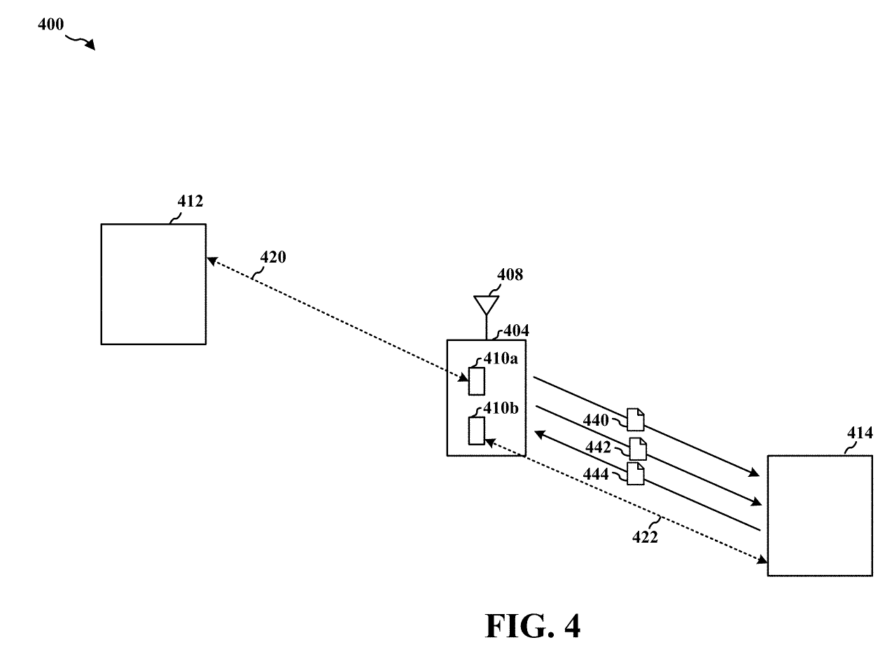

FIG. 4 is a diagram of a wireless communications system 400. The wireless communications system 400 may include at least a DSDS device 404, a first network entity 412, and a second network entity 414. In an aspect, the DSDS device 404 may be a UE, such as the UE 104 described with respect to FIG. 1 and/or the UE 350 described with respect to FIG. 3. In an aspect, the first network entity 412 and/or the second network entity 414 may be a base station (e.g., the base station 102 described with respect to FIG. 1 and/or the base station 310 described with respect to FIG. 3), another UE, an AP (e.g., the Wi-Fi AP 150 described with respect to FIG. 1), or another wireless communications device.

According to various aspects, the DSDS device 404 may include at least two SIMs 410a-b, which may comprise two SIMs, three SIMs, or more SIMs depending on the particular configuration of the DSDS device 404. Each of the at least two SIMs 410a-b may allow the DSDS device 404 to communicate with a respective network via a respective network entity 412, 414. That is, the first SIM 410a may provide the DSDS device 404 a subscription to a first network associated with the first network entity 412, and the second SIM 410b may provide the DSDS device 404 a subscription to a second network associated with the second network entity 414.

Each subscription may be associated with a same or different network type. For example, the first SIM 410a may allow the DSDS device 404 to communicate according to a first RAT, and the second SIM 410b may allow the DSDS device 404 to communicate according to a second RAT. According to an example, both SIMs 410a-b support LTE subscriptions (e.g., the DSDS device 404 may be an L+L device).

In one aspect, the first SIM 410a may provide an IMS subscription, whereas the second SIM 410b may provide an IMS and data (i.e., IMS+data) subscription. The second SIM 410b may provide a designated data subscription (DDS) (e.g., Internet traffic that may not operate on top of IMS). For example, the second SIM 410b may enable rich communication service (RCS) for data communication (e.g., file transfer, group chat, and the like).

According to an aspect, the DSDS device 404 may include an RF resource 408 (e.g., an RF chain, transceiver, etc.) that is shared between the two SIMs 410a-b. That is, the DSDS device 404 may communicate using the RF resource 408 for both SIMs 410a-b. Therefore, the DSDS device 404 may cause the RF resource 408 to tune to one of the SIMs 410a-b at a time. Consequently, the DSDS device 404 may not actively communicate (e.g., send and/or receive) using both SIMs 410a-b simultaneously, even though the DSDS device 404 may contemporaneously maintain active communication sessions using both SIMs 410a-b. For example, the DSDS device 404 may tune to the first SIM 410a to send voice signaling, which may prevent simultaneous data transmission by the second SIM 410b.

Use of the RF resource 408 by both SIMs 410a-b may cause interruptions to the one of the SIMs 410a-b when the RF resource 408 is not tuned to that one of the SIMs 410a-b. For example, when the second SIM 410b is engaged in active data transfer, the DSDS device 404 may interrupt the active data transfer by tuning the RF resource 408 to the first SIM 410a instead of the second SIM 410b. The sharing of the RF resource 408 may cause degradation of performance, such as by retransmission by the second SIM 410b, which may increase signaling overhead (e.g., at the L1, RLC/MAC, TCP, or other layers of the DSDS device 404).

In order to reduce overhead and improve performance, the DSDS device 404 may pause communication through the second SIM 410b when the RF resource is tuned to the first SIM 410a. For example, the DSDS device 404 may indicate to the second network entity 414 that active data transfer is to be paused, allowing the first SIM 410a to communicate through the RF resource 408. This indication may reduce signaling overhead on the second subscription, such as when the second SIM 410b is engaged in active IMS data transfer with services like RCS-enabled file transfer, group chatting, short message service (SMS), and similar services that may rely on acknowledged-mode communication.

According to an aspect, the DSDS device 404 may be contemporaneously engaged in two active communication sessions: a first active communication session 420 with the first network entity 412 using the first SIM 410a and a second active communication session 422 with the second network entity 414 using the second SIM 410b. Contemporaneous active communication sessions may indicate that the DSDS device 404 maintains information associated with those contemporaneous active communication sessions because those contemporaneous active communication sessions exist at least partially during a same time period, even though the DSDS device 404 may be unable to simultaneously communicate with both contemporaneous active communication sessions due to the shared RF resource 408.

The DSDS device 404 may determine that the first communication session 420 and the second communication session 422 are contemporaneously active. For example, the DSDS device 404 may determine that the second communication session 422 is associated with active data transfer with the second network entity 414, and the first communication session 420 is associated with a voice-only service with the first network entity 412. The DSDS device 404 may determine that the RF resource 408 is to be tuned to the first SIM 410a and, therefore, the active data transfer through the second SIM 410b is to be paused. In other words, the DSDS device 404 may determine that the DSDS device 404 is to communicate in the first communication session 420 instead of the second communication session 422 when the first communication session 420 and the second communication session 422 are contemporaneously active. The DSDS device 404 may determine that the DSDS device is to tune the RF resource 408 to the first SIM 410a based on a first priority associated with the first subscription and a second priority associated with the second subscription (e.g., the first subscription may take precedence over the second subscription because voice/video calling may take precedence over DDS or other data).

Based on the determination that the DSDS device 404 is to communicate in the first communication session 420 instead of the second communication session 422 (e.g., based on a determination that the RF resource 408 is to be tuned to the first SIM 410a instead of the second SIM 410b), the DSDS device 404 may generate a first SIP message 440. The DSDS device 404 may generate the first SIP message 440 in order to pause the second communication session 422 with the second network entity 414.

In one aspect, the DSDS device 404 may generate the first SIP message 440 to indicate that the second network entity 414 is to stop or pause communication of data with the DSDS device 404. For example, the DSDS device 404 may generate the first SIP message 440 as a SIP Re-INVITE or a SIP UPDATE. The DSDS device 404 may generate the first SIP message 440 to include an SDP parameter that requests the second network entity 414 to stop or pause communication of data with the DSDS device 404. In one aspect, the SDP parameter may indicate that the DSDS device 404 is to be in a send only state (e.g., the SDP parameter may include “a=sendonly”). In another aspect, the SDP parameter may indicate that the DSDS device 404 is to be in an inactive state (e.g., the SDP parameter may include “a=inactive”). The DSDS device 404 may be in the send only state or the inactive state after the DSDS device 404 sends the first SIP message 440.

The DSDS device 404 may transmit the first SIP message 440 to the second network entity 414 in order to pause the second communication session 422. For example, the SDP parameter of the first SIP message 440 may indicate to the second network entity 414 that the DSDS device 404 is not to receive data from the second network entity 414. Responsively, the second network entity 414 may stop or pause data communication with the DSDS device 404. However, the second communication session 422 may remain active (e.g., the DSDS device 404 may maintain information associated with the second communication session 422 so that the second communication session 422 may be resumed).

Accordingly, the DSDS device 404 may resume or initiate the first communication session 420 associated with the first network entity 412. For example, the DSDS device 404 may tune the RF resource 408 to the first SIM 410a and engage in a voice-only service through the first network entity 412. Subsequently, the DSDS device 404 may determine that the first communication session 420 has ended or is to be paused and, therefore, the DSDS device 404 may resume the second communication session 422 by tuning the RF resource 408 to the second SIM 410b.

In one aspect, the DSDS device 404 may generate a second SIP message 442 in order to request resumption of the second communication session 422 through the second SIM 410b. For example, the DSDS device 404 may generate the second SIP message 442 as a SIP Re-INVITE or a SIP UPDATE. The DSDS device 404 may generate the second SIP message 442 to include an SDP parameter that requests the second network entity 414 to resume transmitting data to the DSDS device 404. In one aspect, the SDP parameter may indicate that the DSDS device 404 is to be in a send and receive state (e.g., the SDP parameter may include “a=sendrecv”). The DSDS device 404 may be in the send and receive state after the DSDS device 404 sends the first SIP message 442.

According to one aspect, the DSDS device 404 may send the second SIP message 442 when the DSDS device 404 is unaware of the duration for which the RF resource 408 is to be tuned to the first SIM 410a. For example, the DSDS device 404 may determine that the RF resource 408 is to be tuned to the first SIM 410a for an unknown duration. When the first communication session 420 has ended or is paused, the DSDS device 404 may determine that the second communication session is to resume. Based on the determination that the second communication system is to resume, the DSDS device 404 may generate the second SIP message 442. The DSDS device 404 may then transmit the second SIP message 442 to the second network entity 414.

Based on the second SIP message 442, the second network entity 414 may transmit, to the DSDS device 404, an acknowledgement message 444. For example, the acknowledgement message 444 may be a 200 OK message, which may indicate a successful request. The DSDS device 404 may receive the acknowledgement message 444. The DSDS device 404 may resume the second communication session 422 with the second network entity 414, such as by resuming active data transfer.

According to one aspect, the DSDS device 404 may determine a duration for which the RF resource 408 is to be tuned to the first SIM 410a. For example, the DSDS device 404 may estimate the time at which the first communication session 420 is to end or be paused and, therefore, the DSDS device 404 may estimate the time at which the second communication session 422 may resume. In such an aspect, the DSDS device 404 may inform the second network entity 414 of the time at which the second communication session 422 is to resume. In one aspect, the DSDS device 404 may refrain from transmitting the second SIP message 442 because the DSDS device 404 may inform the second network entity 414 of the time at which to resume the second communication session 422 when requesting the second network entity 414 to pause the second communication session 422.

Based on the determination of the time at which the second communication session 422 is to resume, the DSDS device 404 may indicate the time at which the second communication session 422 is to resume to the second network entity 414. The DSDS device 404 may include an indication of the time at which the second communication session 422 is to resume in the first SIP message 440. For example, the DSDS device 404 may include one or more SDP parameters in the first SIP message 440 to indicate the duration for which the second communication session 422 is to be paused.

In one aspect, the DSDS device 404 may include a plurality of values associated with time in the at least one SDP parameter of the first SIP message 440 (e.g., the DSDS device 404 may use two “t=<startTime><stopTime>” lines in the at least one SDP parameter). For example, the DSDS device 404 may determine an absolute start time of the second communication session 422 and include a first start time parameter in the first SIP message 440 that indicates this absolute start time. The DSDS device 404 may determine an absolute pause time at which the second communication session 422 is to be paused and include a first stop time parameter that indicates this absolute pause time. The DSDS device 404 may determine a resumption time (e.g., the estimated time after the first communication session 420 is to be stopped or paused and the second communication session 422 may resume) and include a second start time parameter that indicates this resumption time. The DSDS device 404 may determine the resumption time as a current time+Ti, where Ti is the determined or estimated duration before which the RF resource 408 is to be tuned to the second SIM 410b. The DSDS device 404 may determine a second stop time to indicate whether there is a subsequent stop time associated with the second communication session 422 and include a second stop time parameter that indicates whether there is a subsequent stop time associated with the second communication session 422. In one aspect, the DSDS device 404 may include a predetermined value (e.g., “0”) as the second stop time parameter in order to indicate that there is no determined or estimated stop time for the second communication session 422.

In such an aspect, the second network entity 414 may receive the first SIP message 440, which includes the at least one SDP parameter indicating a time at which the second communication session 422 may resume. Responsively, the second network entity 414 may resume the second communication session 422. For example, the DSDS device 404 may resume an active data transfer associated with the second communication session 422, for instance, at the indicated resumption time. By indicating a resumption time in the first SIP message 440, the DSDS device 404 may prevent retransmissions at one or more layers of the DSDS device 404, which may improve efficiency of the communication link associated with the second communication session 422 and/or reduce signaling overhead.

By causing the second network entity 414 to pause the second communication session 422, the DSDS device 404 may improve operation of data transfer (e.g., RCS) while utilizing a shared RF resource 408. Moreover, the second network entity 414 may experience an improved communication link because retransmissions may be avoided, which may also reduce power consumption by the DSDS device 404 and/or the second network entity 414. Additionally, the second network entity 414 may be able to schedule other operations during the suspension of the second communication session 422 (e.g., when the second network entity 414 is a multi-SIM device with a shared transceiver).

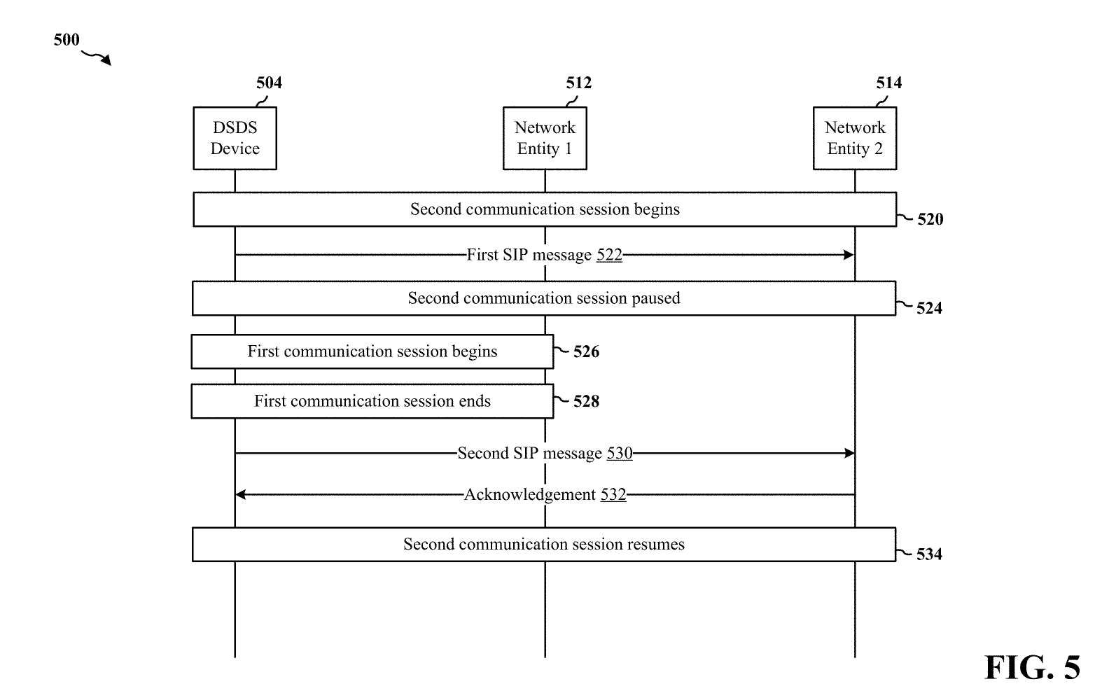

FIG. 5 is a call flow diagram of a wireless communications system 500. In an aspect, the wireless communications system 500 may illustrate the flow of operations described with respect to FIG. 4. Thus, the DSDS device 504 may be an aspect of the DSDS device 404, the first network entity 512 may be an aspect of the first network entity 412, and the second network entity 514 may be an aspect of the second network entity 414.

Beginning at operation 520, the DSDS device 504 may begin a second communication session with a second network entity 514. For example, the DSDS device 504 may be engaged in active data transfer (e.g., RCS-enabled file transfer, group chat, etc.) associated with the second communication session. Accordingly, the DSDS device 504 may tune an RF resource for the second communication session with the second network entity 514.

The DSDS device 504 may determine that the RF resource of the DSDS device 504 is to be engaged for another communication session. For example, the RF resource may be shared between at least two SIMs of the DSDS device 504 and, therefore, the RF resource may be tuned at one time to only one SIM of the at least two SIMs. Thus, while the DSDS device 504 may be contemporaneously engaged in more than one communication session, the RF resource may be tuned to only one SIM associated with one of the more than one contemporaneous communication sessions.

Based on the determination that the RF resource of the DSDS device 504 is to be tuned to another communication session (e.g., a first communication session), the DSDS device 504 may generate a first SIP message in order to pause the second communication session, for example, so that the RF resource may be tuned for another communication session and to avoid retransmissions, lost data, etc. The DSDS device 504 may generate the first SIP message in order to indicate to the second network entity 514 that the second network entity 514 is to refrain from transmission to the DSDS device 504 (e.g., the first SIP message may indicate that the DSDS device 504 is to be in an inactive or send-only state). In one aspect, the DSDS device 504 may generate the first SIP message to indicate a time at which the second network entity 514 may resume transmission to the DSDS device 504 during the second communication session (see, e.g., operation 534). At operation 522, the DSDS device 504 may transmit, to the second network entity 514, the first SIP message. In connection therewith, the second communication session may be paused, as illustrated at operation 524.

At operation 526, the DSDS device 504 may begin a first communication session with the first network entity 512. The first communication session may be associated with a voice service. For example, the DSDS device 504 may tune the RF resource from the second communication session to the first communication session. Accordingly, the first and second communication sessions may occur contemporaneously, though the DSDS device 504 may have the RF resource tuned for only one communication session at a time.

At operation 528, the first communication session may end or may be paused, which may free the RF resource for the second communication session. Therefore, the DSDS device 504 may be able to tune the RF resource for the second communication session.

In one aspect, the first SIP message may indicate a time at which the second communication session may resume. In such an aspect, operations 530 and/or 532 may be omitted, for example, because the second network entity 514 may resume the second communication session in accordance with the time indicated in the first SIP message. At operation 534, therefore, the second communication session may resume, for example, at the indicated time (e.g., before which the DSDS device 504 may tune the RF resource to the second SIM associated with the second communication session).

In another aspect, the DSDS device 504 may determine that the second communication session is to resume and the second network entity 514 should be notified of the same. The DSDS device 504 may generate a second SIP message that indicates that the second network entity 514 may resume the second communication session. For example, the second SIP message may indicate that the DSDS device 504 is to be in a send and receive state. At operation 530, the DSDS device 504 may transmit the second SIP message to the second network entity 514.

Based on the second SIP message, the second network entity 514 may generate an acknowledgement in order to indicate that the second network entity 514 will resume the second communication session. At operation 532, the second network entity 514 may transmit the acknowledgement to the DSDS device 504. At operation 534, the DSDS device 504 and the second network entity 514 may resume the second communication session, such as by resuming an active data transfer after the DSDS device 504 tunes the RF resource for the second communication session.

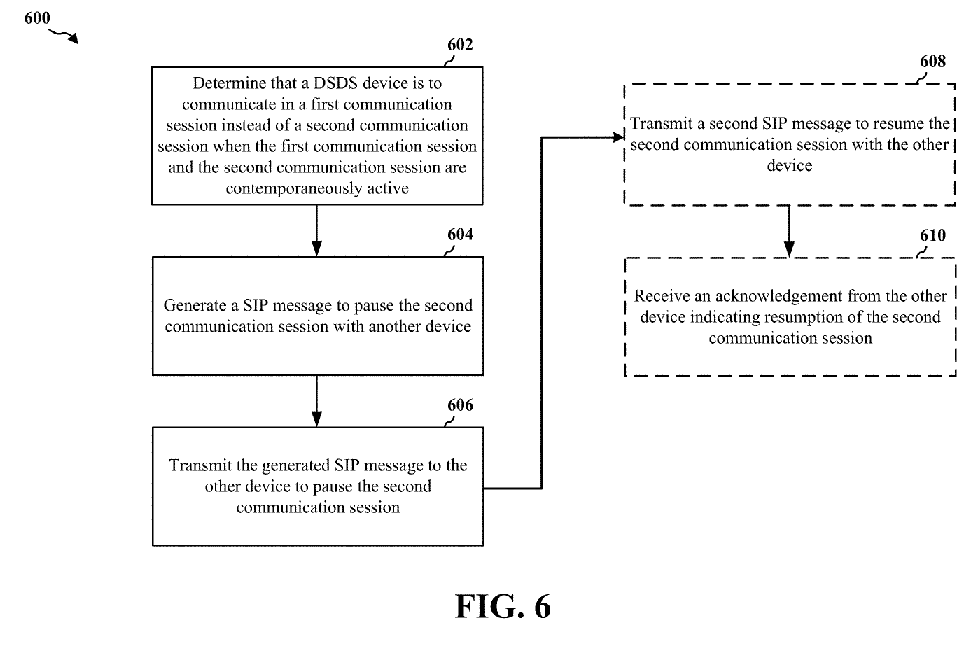

FIG. 6 is a flowchart illustrating a method 600 of wireless communication. The method 600 may be performed by a DSDS device, such as the DSDS device 404 of FIG. 4 and/or the DSDS device 504 of FIG. 5. According to various aspects, one or more of the illustrated operations may be omitted, transposed, and/or contemporaneous. In an aspect, additional operations may occur.

At operation 602, the DSDS device may determine that the DSDS device is to communicate in a first communication session of the DSDS device instead of a second communication session of the DSDS device when the first communication session and the second communication session are contemporaneously active. For example, the DSDS device may determine that an RF resource of the DSDS device is to be tuned for the first communication session instead of the second communication session, and may determine that data transfer of the second communication session is to be paused. The DSDS device may tune the RF resource for the first communication session instead of the second communication session. However, the DSDS device may maintain information (e.g., state information) for both the first and second communication sessions, even though the RF resource may be tuned for only one of the first and second communication sessions.

In the context of FIG. 4, the DSDS device 404 may determine that both the first communication session 420 and the second communication session 422 are contemporaneously active. However, the DSDS device 404 may determine that the RF resource 408 is to be tuned to the first SIM 410a for the first communication session 420, and may determine that data transfer associated with the second communication session 422 is to be paused at least while the RF resource is tuned to the first SIM 410a. In the context of FIG. 5, the DSDS device 504 may begin the first communication session (operation 526), while the second communication session is paused (operation 524).

At operation 604, the DSDS device may generate a SIP message to pause the second communication session with another device based on the determination that the first communication session and the second communication session associated with the DSDS device are contemporaneously active. According to an aspect, the DSDS device may determine one or more SDP parameters that are to request that the other device stop or pause transmission of data to the DSDS device, and the DSDS device may include the one or more SDP parameters in the generated SIP message. In an aspect, at least one of the SDP parameters may indicate that the DSDS device is to be in an inactive or send only state. For example, the at least one SDP parameter may indicate “a=sendonly” or “a=inactive.”

According to one aspect, the DSDS device may indicate one or more SDP parameters indicating a time duration for which the second communication session is to be paused. For example, the DSDS device may determine (e.g., estimate) a duration of the first communication session, and after the determined duration the second communication session may resume. The DSDS device may determine one or more SDP parameters to indicate the time duration for which the second communication session is to be paused. For example, the DSDS device may determine a first start time parameter that indicates a start time of the second communication session, a first stop time parameter that indicates a time at which the second communication session will be paused, a second start time parameter that indicates a time corresponding to an end of the time duration for which to pause the second communication session, and a second stop time parameter that indicates whether a subsequent stop time is associated with the second communication session. The DSDS device may include, in the generated SIP message, the one or more SDP parameters indicating the time duration for which the second communication session is to be paused.

In the context of FIG. 4, the DSDS device 404 may generate the first SIP message 440. For example, the DSDS device 404 may determine at least one SDP parameter that is to indicate that the second communication session 422 is to be paused, and the DSDS device may include the at least one SDP parameter in the generated first SIP message 440. In one aspect, the DSDS device 404 may determine (e.g., estimate) a time duration for which the second communication session 422 is to be paused (e.g., the DSDS device 404 may estimate a duration of the first communication session 420, which may include a time to tune the RF resource 408 between the first SIM 410a and the second SIM 410b). The DSDS device 404 may determine one or more SDP parameters to indicate the determined time duration. The DSDS device 404 may include, in the first SIP message 440, the one or more SDP parameters that indicate the determined time duration for which the second communication session 422 is to be paused. In the context of FIG. 5, the DSDS device 504 may generate the first SIP message (transmitted at operation 522).

At operation 606, the DSDS device may transmit the generated SIP message to the other device to pause the second communication session associated with the other device. In the context of FIG. 4, the DSDS device 404 may transmit the first SIP message 440 to the second network entity 414 in order to pause the second communication session 422. In one aspect, the DSDS device 404 may tune the RF resource 408 from the second SIM 410b to the first SIM 410a. In the context of FIG. 5, the DSDS device 504 may transmit the first SIP message (operation 522).

In one aspect, the DSDS device may resume the second communication session without additional signaling to the other device, such as when the DSDS device is able to determine (e.g., estimate) the time duration of the first communication session and indicate the determine time duration to the other device in the generated SIP message.

In another aspect, the DSDS may explicit signal (e.g., request) the other device to resume the second communication session. Accordingly, the DSDS device may generate a second SIP message to resume the second communication session with the other device. For example, the DSDS device may determine at least one SDP parameter that indicates that the second communication session is to resume, such as an SDP parameter that indicates that the DSDS device is to be in a send and receive state. The DSDS device may include the determined at least one SDP parameter in the generated second SIP message. At operation 608, the DSDS device may transmit the second SIP message to resume the second communication session, and the second SIP message may include the SDP parameter indicating that the DSDS device is to be in the send and receive state.

In the context of FIG. 4, the DSDS device 404 may generate the second SIP message 442. The DSDS device 404 may determine an SDP parameter indicating that the DSDS device 404 is to be in a send and receive state. The DSDS device 404 may transmit, to the second network entity 414, the generated second SIP message 442. In the context of FIG. 5, the DSDS device 504 may transmit the second SIP message (operation 530).

At operation 610, the DSDS device may receive, from the other device, an acknowledgement indicating resumption of the second communication session. The acknowledgement may be received by the DSDS device in response to the second SIP message. In connection therewith, the DSDS device may tune an RF resource of the DSDS device for the second communication session.

In the context of FIG. 4, the DSDS device 404 may receive, from the second network entity 414, the acknowledgement message 444. The DSDS device 404 may tune the RF resource 408 to the second SIM 410b for the second communication session 422. The DSDS device 404 may resume the second communication session 422 with the second network entity 414, such as by receiving data transfer from the second network entity 414. In the context of FIG. 5, the DSDS device 504 may receive the acknowledgement (operation 532), and the DSDS device 504 may resume the second communication session (operation 534).

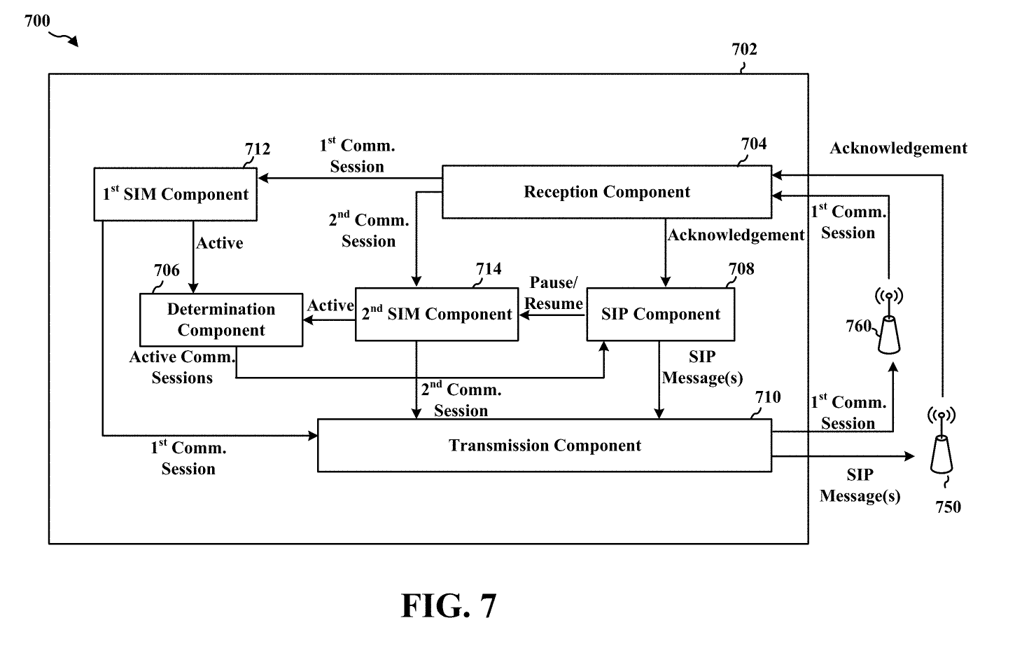

FIG. 7 is a conceptual data flow diagram 700 illustrating the data flow between different means/components in an exemplary apparatus 702. The apparatus 702 may be a DSDS device (e.g., the UE 104, the DSDS device 404, the DSDS device 504, or another device). The apparatus 702 may include additional/other components and/or may include additional/other data flow.

The apparatus 702 may include a reception component 704 configured to receive signals, for example, from a first network entity 760 and/or a second network entity 750. The apparatus 702 may include a transmission component 710 configured to transmit signals, for example, to the first network entity 760 and/or the second network entity 750. Collectively, the reception component 704 and the transmission component 710 may function as an RF resource of the apparatus 702. The reception component 704 and the transmission component 710 may be shared between a first SIM component 712 and a second SIM component 714.

The first SIM component 712 may be configured to engage in a first communication session. The first SIM component 712 may provide an IMS subscription. For example, the first SIM component 712 may provide voice and/or video calling services. When engaged in an active communication session, the first SIM component 712 may receive signals through the reception component 704 and send signals through the transmission component 710. In an aspect, the first SIM component 712 may indicate, to a determination component 706, that a first communication session is active.

The second SIM component 714 may be configured to engage in a second communication session. The second SIM component 714 may provide an IMS and data (i.e., IMS+data) subscription. The second SIM component 714 may provide DDS (e.g., Internet traffic that may not operate on top of IMS). For example, the second SIM component 714 may enable RCS for data communication (e.g., file transfer, group chat, and the like). When engaged in an active communication session, the second SIM component 714 may receive signals through the reception component 704 and send signals through the transmission component 710. In an aspect, the second SIM component 714 may indicate, to the determination component 706, that a second communication session is active.

The determination component 706 may be configured to determine that a first communication session associated with the first SIM component 712 and a second communication session associated with the second SIM component 714 are contemporaneously active. For example, the determination component 706 may determine that state information is maintained for two communication sessions, while the reception component 704 and/or the transmission component 710 are tuned to one of the first SIM component 712 or the second SIM component 714 for a respective first or second communication session.

In an aspect, the determination component 706 may receive an indication from the second SIM component 714 that the second communication session is active (e.g., active data transfer is occurring with the second network entity 750). The determination component 706 may determine that a first communication session is active (e.g., becoming active, such as during an incoming call or a placed call), which may require the reception component 704 and the transmission component 710 to be tuned to the first SIM component 712. The determination component 706 may determine that the second communication session is to be paused in order for the reception component 704 and the transmission component 710 to be tuned to the first SIM component 712 for the first communication session. Thus, the determination component 712 may determine that the apparatus 702 is to communicate in the first communication session instead of the second communication session when the first communication session and the second communication session are contemporaneously active. The determination component 706 may provide an indication that the second communication session is to be paused to a SIP component 708.

In one aspect, the determination component 706 may be configured to determine a time duration for which the second communication session is to be paused. For example, the determination component 706 may determine or estimate a duration of the first communication session. In one aspect, the determination component 706 may include, in the determined time duration for which the second communication session is to be paused, a duration required for tuning the reception component 704 and the transmission component 710 between the first SIM component 712 and the second SIM component 714. The determination component 706 may provide, to the SIP component 708, an indication of the determined time at which the second communication session is to be paused.

In another aspect, the determination component 706 may be configured to determine a time at which the first communication session has ended or has been paused. The determination component 706 may provide an indication of the end time or pause time of the first communication session to the SIP component 708 in order to resume the second communication session.

The SIP component 708 may be configured to generate a first SIP message. The SIP component 708 may generate the first SIP message to pause the second communication session with the second network entity 750, for example, based on the determination that the DSDS device is to communicate in the first communication session instead of the second communication session. In one aspect, the SIP component 708 may generate the first SIP message to include at least one SDP parameter that requests the second network entity 750 to stop transmitting data to the apparatus 702. For example, the SDP parameter may indicate that the apparatus 702 is to be in an inactive state or a send only state. The SIP component 708 may provide the first SIP message to the transmission component 710 for transmission to the second network entity 750.

When the determination component 706 provides an indication of a time at which the second communication session is to be paused, the SIP component 708 may generate the first SIP message to include one or more SDP parameters that indicate the time at which the second communication session is to be paused and the time at which the second communication session is to resume. For example, the SIP component 708 may generate the first SIP message to include a plurality of SDP parameters: a first start time parameter that indicates a start time of the second communication session; a first stop time parameter that indicates a time at which the second communication session will be paused; a second start time parameter that indicates an end time after which the second communication session may resume; and a second stop time parameter that indicates whether a subsequent stop time is associated with the second communication session. Accordingly, the second network entity 750 may autonomously resume the second communication session (e.g., absent explicit signaling indicating the second communication session is to resume).

In one aspect, the SIP component 708 may generate a second SIP message to resume the second communication session. For example, the determination component 706 may indicate, to the SIP component 708, that the second communication session is to resume (e.g., when the first communication session has ended or paused). Based on the indication that the second communication session is to resume, the SIP component 708 may generate the second SIP message. The SIP component 708 may generate the second SIP message to include at least one SDP parameter that indicates that the apparatus 702 is to be in a send and receive state. The SIP component 708 may provide the second SIP message to the transmission component 710 for transmission to the second network entity 750.

In an aspect, the SIP component 708 may receive, from the second network entity 750, an acknowledgment indicating resumption of the second communication session (e.g., in response to the second SIP message). The SIP component 708 may indicate to the second SIM component 714 that the second communication session is to resume based on the received acknowledgement.

When the second communication session resumes, the reception component 704 and the transmission component 710 may be tuned to the second SIM component 714.

The apparatus may include additional components that perform each of the blocks of the algorithm in the aforementioned flowcharts of FIGS. 5 and 6. As such, each block in the aforementioned flowcharts of FIGS. 5 and 6 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

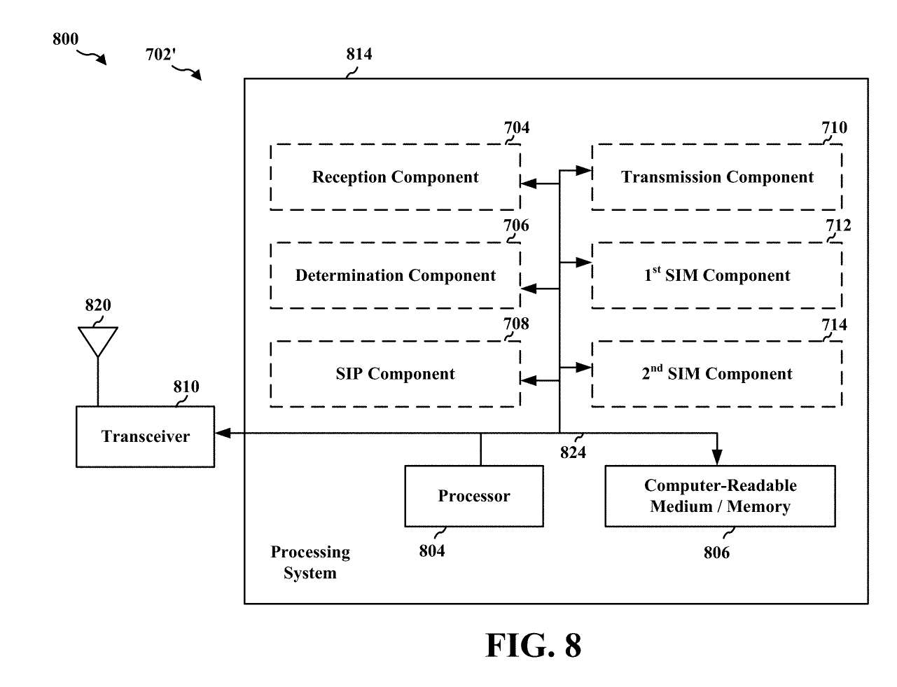

FIG. 8 is a diagram 800 illustrating an example of a hardware implementation for an apparatus 702′ employing a processing system 814. The processing system 814 may be implemented with a bus architecture, represented generally by the bus 824. The bus 824 may include any number of interconnecting buses and bridges depending on the specific application of the processing system 814 and the overall design constraints. The bus 824 links together various circuits including one or more processors and/or hardware components, represented by the processor 804, the components 704, 706, 708, 710, 712, 714 and the computer-readable medium/memory 806. The bus 824 may also link various other circuits such as timing sources, peripherals, voltage regulators, and power management circuits, which are well known in the art, and therefore, will not be described any further.

The processing system 814 may be coupled to a transceiver 810. The transceiver 810 is coupled to one or more antennas 820. The transceiver 810 provides a means for communicating with various other apparatus over a transmission medium. The transceiver 810 receives a signal from the one or more antennas 820, extracts information from the received signal, and provides the extracted information to the processing system 814, specifically the reception component 704. In addition, the transceiver 810 receives information from the processing system 814, specifically the transmission component 710, and based on the received information, generates a signal to be applied to the one or more antennas 820. The processing system 814 includes a processor 804 coupled to a computer-readable medium/memory 806. The processor 804 is responsible for general processing, including the execution of software stored on the computer-readable medium/memory 806. The software, when executed by the processor 804, causes the processing system 814 to perform the various functions described supra for any particular apparatus. The computer-readable medium/memory 806 may also be used for storing data that is manipulated by the processor 804 when executing software. The processing system 814 further includes at least one of the components 704, 706, 708, 710, 712, 714. The components may be software components running in the processor 804, resident/stored in the computer readable medium/memory 806, one or more hardware components coupled to the processor 804, or some combination thereof. The processing system 814 may be a component of the UE 350 and may include the memory 360 and/or at least one of the TX processor 368, the RX processor 356, and the controller/processor 359.

In one configuration, the apparatus 702/702′ for wireless communication includes means for determining that the apparatus 702/702′ is to communicate in a first communication session of the apparatus 702/702′ instead of a second communication session of the apparatus 702/702′ when the first communication session and the second communication session of the apparatus 702/702′ are contemporaneously active. The apparatus 702/702′ may include means for generating a SIP message to pause the second communication session with another device based on the determination that the apparatus 702/702′ is to communicate in the first communication session instead of the second communication session associated with the apparatus 702/702′. The apparatus 702/702′ may include means for transmitting the generated SIP message to the other device associated with second communication session to pause the second communication session associated with the other device.

In an aspect, the generated SIP message comprises an SDP parameter that requests the other device to stop transmitting data to the apparatus 702/702′. In an aspect, the SDP parameter indicates that the apparatus 702/702′ is to be in an inactive state or a send only state. In an aspect, the generated SIP message further comprises one or more additional SDP parameters indicating a time duration for which to pause the second communication session. In an aspect, the one or more additional SDP parameters comprises: a first start time parameter that indicates a start time of the second communication session; a first stop time parameter that indicates a time at which the second communication session will be paused; a second start time parameter that indicates a time corresponding to an end of the time duration for which to pause the second communication session; and a second stop time parameter that indicates whether a subsequent stop time is associated with the second communication session.

The apparatus 702/702′ may include means for transmitting a second SIP message to resume the second communication session with the other device, the second SIP message comprising a SDP parameter indicating that the apparatus 702/702′ is to be in a send and receive state. In an aspect, the apparatus 702/702′ may include means for receiving an acknowledgment from the other device indicating resumption of the second communication session.

The aforementioned means may be one or more of the aforementioned components of the apparatus 702 and/or the processing system 814 of the apparatus 702′ configured to perform the functions recited by the aforementioned means. As described supra, the processing system 814 may include the TX Processor 368, the RX Processor 356, and the controller/processor 359. As such, in one configuration, the aforementioned means may be the TX Processor 368, the RX Processor 356, and the controller/processor 359 configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of wireless communication by a dual subscriber identity module (SIM) dual standby (DSDS) device, comprising:
determining that the DSDS device is to communicate in a first communication session of the DSDS device instead of a second communication session of the DSDS device when the first communication session of the DSDS device and the second communication session of the DSDS device are contemporaneously active;
generating a session initiation protocol (SIP) message to pause the second communication session with another device based on the determination that the DSDS device is to communicate in the first communication session instead of the second communication session associated with the DSDS device; and
transmitting the generated SIP message to the other device associated with second communication session to pause the second communication session associated with the other device.

2. The method of claim 1, wherein the generated SIP message comprises:
a session description protocol (SDP) parameter that requests the other device to stop transmitting data to the DSDS device.

3. The method of claim 2, wherein the SDP parameter indicates that the DSDS device is to be in an inactive state or a send only state.

4. The method of claim 2, wherein the generated SIP message further comprises one or more additional SDP parameters indicating a time duration for which to pause the second communication session.

5. The method of claim 4, wherein the one or more additional SDP parameters comprises:
a first start time parameter that indicates a start time of the second communication session;
a first stop time parameter that indicates a time at which the second communication session will be paused;
a second start time parameter that indicates a time corresponding to an end of the time duration for which to pause the second communication session; and
a second stop time parameter that indicates whether a subsequent stop time is associated with the second communication session.

6. The method of claim 1, further comprising:
transmitting a second SIP message to resume the second communication session with the other device, the second SIP message comprising a session description protocol (SDP) parameter indicating that the DSDS device is to be in a send and receive state.

7. The method of claim 6, further comprising:
receiving an acknowledgment from the other device indicating resumption of the second communication session.

8. A dual subscriber identity module (SIM) dual standby (DSDS) device comprising:
means for determining that the DSDS device is to communicate in a first communication session of the DSDS device instead of a second communication session of the DSDS device when the first communication session of the DSDS device and the second communication session of the DSDS device are contemporaneously active;
means for generating a session initiation protocol (SIP) message to pause the second communication session with another device based on the determination that the DSDS device is to communicate in first communication session instead of the second communication session associated with the DSDS device; and
means for transmitting the generated SIP message to the other device associated with second communication session to pause the second communication session associated with the other device.

9. The DSDS device of claim 8, wherein the generated SIP message comprises:
a session description protocol (SDP) parameter that requests the other device to stop transmitting data to the DSDS device.

10. The DSDS device of claim 9, wherein the SDP parameter indicates that the DSDS device is to be in an inactive state or a send only state.

11. The DSDS device of claim 9, wherein the generated SIP message further comprises one or more additional SDP parameters indicating a time duration for which to pause the second communication session.

12. The DSDS device of claim 11, wherein the one or more additional SDP parameters comprises:
a first start time parameter that indicates a start time of the second communication session;
a first stop time parameter that indicates a time at which the second communication session will be paused;
a second start time parameter that indicates a time corresponding to an end of the time duration for which to pause the second communication session; and
a second stop time parameter that indicates whether a subsequent stop time is associated with the second communication session.

13. The DSDS device of claim 8, further comprising:
means for transmitting a second SIP message to resume the second communication session with the other device, the second SIP message comprising a session description protocol (SDP) parameter indicating that the DSDS device is to be in a send and receive state.

14. The DSDS device of claim 13, further comprising:
means for receiving an acknowledgment from the other device indicating resumption of the second communication session.

15. An apparatus associated with a dual subscriber identity module (SIM) dual standby (DSDS) device, the apparatus comprising:
a memory; and
at least one processor coupled to the memory and configured to:
determine that the DSDS device is to communicate in a first communication session of the DSDS device instead of a second communication session of the DSDS device when the first communication session of the DSDS device and the second communication session of the DSDS device are contemporaneously active;
generate a session initiation protocol (SIP) message to pause the second communication session with another device based on the determination that the DSDS device is to communicate in the first communication session instead of the second communication session associated with the DSDS device; and
transmit the generated SIP message to the other device associated with second communication session to pause the second communication session associated with the other device.

16. The apparatus of claim 15, wherein the generated SIP message comprises:
a session description protocol (SDP) parameter that requests the other device to stop transmitting data to the DSDS device.

17. The apparatus of claim 16, wherein the SDP parameter indicates that the DSDS device is to be in an inactive state or a send only state.

18. The apparatus of claim 16, wherein the generated SIP message further comprises one or more additional SDP parameters indicating a time duration for which to pause the second communication session.

19. The apparatus of claim 18, wherein the one or more additional SDP parameters comprises:
a first start time parameter that indicates a start time of the second communication session;
a first stop time parameter that indicates a time at which the second communication session will be paused;
a second start time parameter that indicates a time corresponding to an end of the time duration for which to pause the second communication session; and
a second stop time parameter that indicates whether a subsequent stop time is associated with the second communication session.

20. The apparatus of claim 17, wherein the at least one processor is further configured to:
transmit a second SIP message to resume the second communication session with the other device, the second SIP message comprising a session description protocol (SDP) parameter indicating that the DSDS device is to be in a send and receive state.

21. The apparatus of claim 20 wherein the at least one processor is further configured to:
receive an acknowledgment from the other device indicating resumption of the second communication session.

22. A computer-readable medium storing computer-executable code for wireless communication by a dual subscriber identity module (SIM) dual standby (DSDS) device, comprising code to:
determine that the DSDS device is to communicate in a first communication session of the DSDS device instead of a second communication session of the DSDS device when the first communication session of the DSDS device and the second communication session of the DSDS device are contemporaneously active;
generate a session initiation protocol (SIP) message to pause the second communication session with another device based on the determination that the DSDS device is to communicate in the first communication session instead of the second communication session associated with the DSDS device; and
transmit the generated SIP message to the other device associated with second communication session to pause the second communication session associated with the other device.

23. The computer-readable medium of claim 22, wherein the generated SIP message comprises:
a session description protocol (SDP) parameter that requests the other device to stop transmitting data to the DSDS device.

24. The computer-readable medium of claim 23, wherein the SDP parameter indicates that the DSDS device is to be in an inactive state or a send only state.

25. The computer-readable medium of claim 23, wherein the generated SIP message further comprises one or more additional SDP parameters indicating a time duration for which to pause the second communication session.

26. The computer-readable medium of claim 18, wherein the one or more additional SDP parameters comprises:
a first start time parameter that indicates a start time of the second communication session;
a first stop time parameter that indicates a time at which the second communication session will be paused;
a second start time parameter that indicates a time corresponding to an end of the time duration for which to pause the second communication session; and
a second stop time parameter that indicates whether a subsequent stop time is associated with the second communication session.

27. The computer-readable medium of claim 22, further comprising code to:
transmit a second SIP message to resume the second communication session with the other device, the second SIP message comprising a session description protocol (SDP) parameter indicating that the DSDS device is to be in a send and receive state.

28. The computer-readable medium of claim 27, further comprising code to:
receive an acknowledgment from the other device indicating resumption of the second communication session.
